(19) United States
(12) Patent Application Publication
(10) Pub. No.: US 2018/0017217 A1
(43) Pub. Date: Jan. 18, 2018

(54) Floatline Lighting Assembly

(71) Applicants: David Edwin Doubek, La Grange, IL (US); David Jude Ziobro, Fayetteville, GA (US)

(72) Inventors: David Edwin Doubek, La Grange, IL (US); David Jude Ziobro, Fayetteville, GA (US)

(21) Appl. No.: 15/650,254

(22) Filed: Jul. 14, 2017

Related U.S. Application Data
(60) Provisional application No. 62/362,571, filed on Jul. 14, 2016.

(51) Int. Cl. F21V 23/00; F21V 5/04; F21S 8/02; F21V 21/04; F21V 15/01

(52) U.S. Cl. CPC F21K 9/237; F21V 23/002; F21V 21/041; F21V 15/013; F21V 29/70; F21S 8/026; F21K 9/235; F21S 4/28; F21V 5/04

(57) ABSTRACT

A lighting assembly configured to provide a cove lighting effect includes a housing configured to releasably couple a light apparatus comprising a light source coupled to a heat sink. The housing comprises an apparatus portion configured to accommodate the light apparatus, and a wireway configured to accommodate supply wiring for the light apparatus. The housing further includes a trough configured for mounting the housing and for coupling a first housing to a second housing. A light apparatus can include a releasably coupled lens. A light apparatus can releasably engage the housing, and can be removed from the housing when a light source is replaced. A housing front plate can conceal a housing back plate so that only the front plate need be embedded at a wall.

### CROSS REFERENCE TO RELATED APPLICATIONS

This application claims the benefit of U.S. Provisional Application No. 62/362,571 entitled “Floatline Lighting Assembly” filed Jul. 14, 2016 by Mr. David Ziobro and Mr. David Doubek, which is incorporated herein in its entirety by reference.

### FIELD OF INVENTION

This invention relates generally to lighting assemblies, and more particularly to cove lighting assemblies.

### BACKGROUND OF INVENTION

Cove lighting fixtures provide indirect ambient lighting that can be used as both primary lighting and secondary lighting. Cove lighting can be used to highlight a particular architectural feature such as a decorative ceiling or trim, mask flaws with a soft lighting or create a desired pleasing aesthetic effect. Typically, cove lighting fixtures are disposed at the periphery of a room, such as on walls near the ceilings or baseboards, and are mounted in a recess or along a ledge so that the fixtures themselves are concealed while light shines forth and is reflected off a ceiling, wall, floor or other surface. The fixtures can be positioned at gaps in a wall or architectural surface that can be variably shaped to have linear, arcuate, geometrical or other types of profiles.

While often fit for their intended purposes, prior art devices are plagued by several disadvantages and limitations. Many are relatively bulky and have a relatively large depth dimension; and therefore require considerable clearance space at the walls or structures at which they are mounted. This drawback can complicate installation of cove lighting in an existing building, as the fixtures can interfere with existing plumbing and duct work and may require reframing of doors, window sills, headers and other existing architectural features. The increased clearance requirements can also increase costs in new construction when framing sizes, HVAC systems, etc. have to be adjusted to accommodate cove lighting features.

In general, a cove lighting fixture has a housing that holds radiant light elements, and the housing must be concealed at an architectural structure. In many cases in the prior art, a back plate of a lighting device is mounted to a wall with screws and is subsequently be spackled over so that it is not readily visible to the casual observer. The forces applied by the screws can cause a rippling effect in back plate, often referred to as “oil canning”. In addition, the mounting screws can cause the edges and corners of the back plate to be raised with respect to the mounting surface. Both effects can complicate the spackling process. In addition, not only can the raised edges can be difficult to spackle, paint over, and adequately feather to conceal the height differences; but they may cause the applied drywall mud to crack after a period of time requiring the installation to be repaired or redone.

Another disadvantage often observed in prior art devices is the adhesion of light sources to a permanently installed housing. Should it become necessary to replace the light sources, they must be detached from the housing. In many cases, light sources, such as an array of light-emitting diodes (LEDs) are glued to an inner surface of a housing. When the array is removed, channel surface must be cleaned of the previously applied adhesive. When the array is disposed at a recessed area within a channel recessed in drywall, it can be difficult for an operator to visually verify that all residual adhesive is removed from the channel surface and that the channel is free of oil, dust and debris prior to inserting and adhering a new strip of LEDs. If the channel is not adequately cleaned, the newly installed LED strip may not remain adhered within the channel. In addition, air bubbles can form that impede the transfer of heat away from the LED strip and cause premature failure of the light strip.

Finally, due to space constraints at prior art cove light apparatus, light sources at a light fixture are typically powered by supply wiring coupled to the light array at one end of a light fixture housing. When several housing sections are coupled together, the multiply light arrays are interconnected and powered by the single supply wiring connection. For lengthy fixtures, such as those that span an entire wall, a lower voltage is supplied to lights at the end of the run, causing a decreased lumen output, and a non-uniform light display.

### SUMMARY OF THE INVENTION

In an example embodiment of the invention, a lighting assembly is configured to provide a “floating” effect through indirect lighting. By way of example, a lighting assembly comprises a light apparatus releasably secured within a housing that can be mounted to an architectural surface. The housing includes a channel configured to receive and releasably engage the light apparatus, and a trough configured to receive a screw for mounting the housing to a wall, ceiling or other mounting surface. Mounting the assembly through a trough, as opposed to a channel back plate or front plate as commonly practiced, protects the channel against ripples that are often produced when screws are applied. The trough can also be configured to couple a first housing to a second housing to provide a lighting assembly of a desired length for an intended application. A light apparatus can comprise a light source, such as one or more light-emitting diodes (LEDs), coupled to a heat sink. By way of example, a light apparatus can further comprise a releasably coupled lens. A lens can be configured to diffuse light emitted by the light source, and, in addition, secure the light apparatus within the housing.

In an example embodiment, a lighting assembly includes a light apparatus comprising a light source coupled to a heat sink, and a housing having a channel configured for receiving, engaging and securing said light apparatus. The light apparatus includes a coupling component configured to releasably engage the housing. By way of example, the coupling component can comprise a z-foot configured to engage a front plate of the channel. A light apparatus can be moved through a plurality of positions with respect to the housing, including: (1) an outer unengaged position in which the light apparatus is within the channel, the coupler component does not engage the housing, and the light apparatus is less deep into the channel than in an engaged position; (2) an inner unengaged position in which the light apparatus is within the channel, the coupler component does not engage the housing and the light apparatus is at a position that is deeper into the channel than the engaged position; and (3) an engaged/locked position in which the light apparatus is within the channel and the coupling component releasably engages the housing.

By way of example, a light apparatus can be decoupled from the housing by pushing it from the engaged position to the inner unengaged position and then pulling it out to the outer unengaged position. In an example embodiment, the heat sink of the light apparatus comprises a pry-out divot for facilitating the decoupling of the light apparatus from the housing. The light apparatus can comprise a lens adapted to engage the channel and function as a spring applying a force that friction fits the coupling component with the channel. In an alternative embodiment, the heat sink can comprise a spring.

An example lighting assembly comprises a light source, and a housing configured to receive and support the light source. An example housing comprises a front plate, a back plate and a base arranged to provide a channel having an apparatus portion configured to accommodate the light source and a wireway cavity portion configured to accommodate supply wiring for the light source. In an example embodiment, a heat sink coupled to the light source is disposed between the light source and the supply wiring. The heat sink can be releasably coupled to the housing; enabling its removal from an embedded housing should a light source need to be replaced.

### BRIEF DESCRIPTION OF THE DRAWINGS

FIG. 1 shows an example lighting assembly mounted at a wall.

FIG. 2 shows an example housing of a lighting assembly.

FIG. 3 shows two example housings coupled together.

FIG. 4 shows an example heat sink coupled to an example light source.

FIG. 5 depicts an example lens.

FIG. 6 shows an example embodiment of a lighting assembly.

FIG. 7 shows an example embodiment of a component coupler.

FIG. 8 shows a flow diagram of an example method.

FIG. 9A shows a possible position of an example light apparatus with respect to an example housing.

FIG. 9B shows a possible position of an example light apparatus with respect to an example housing.

FIG. 9C shows a possible position of an example light apparatus with respect to an example housing.

FIG. 10 shows a flow diagram of an example method.

FIG. 11 shows an example embodiment of a lighting assembly.

FIG. 12A shows a rear view of the example embodiment of a lighting assembly of FIG. 11.

FIG. 12B shows a perspective view of the example embodiment of a lighting assembly of FIG. 11.

FIG. 12C shows a perspective view of the example embodiment of a lighting assembly of FIG. 11.

FIG. 12D shows a perspective view of the example embodiment of a lighting assembly of FIG. 11.

FIG. 12E shows an exploded view of the example embodiment of a lighting assembly of FIG. 11.

FIG. 12F shows an exploded view of the example embodiment of a lighting assembly of FIG. 11.

FIG. 13A shows a front view of the example embodiment of FIG. 11.

FIG. 13B shows an exploded front view of the example embodiment of FIG. 11.

FIG. 14 shows a flow diagram of an example method of the invention.

FIG. 15A shows an example embodiment of a lighting assembly concealed by wood trim.

FIG. 15B shows an example embodiment of a lighting assembly in the form of wall art.

### DETAILED DESCRIPTION OF EXAMPLE EMBODIMENTS

Example embodiments of the invention are presented herein; however, the invention may be embodied in a variety of alternative forms, as will be apparent to those skilled in the art. To facilitate understanding of the invention, and provide a basis for the claims, various figures are included in the specification. The figures are not drawn to scale and related elements may be omitted so as to emphasize particular novel features of the invention. Structural and functional details depicted in the figures are provided for the purpose of teaching the practice of the invention to those skilled in the art and are not to be interpreted as limitations. Methods and processes described herein are not limited to the particular sequence in which they are disclosed. While the invention is disclosed in the context of a horizontal structure mounted on an interior wall, it is understood that it can be practiced on both interior and exterior walls, floors, soffits, roofs, and other architectural structures and can be disposed in vertical, diagonal, curved, or other orientations. Directional terms such as “above”, “below”, “under”, “before”, behind”, “horizontal”, “vertical” and other similar terms are not intended to be interpretations as absolutes or limitations, but are simply used for descriptive purposes in describing relational aspects of various features in an example context or embodiment.

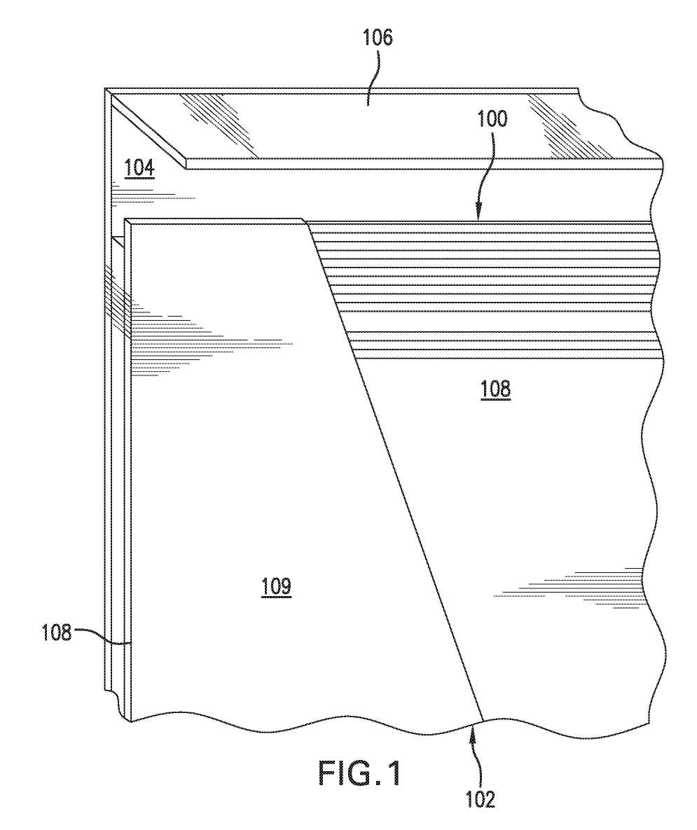

FIG. 1 shows an example lighting assembly 100 mounted at a wall 102. Light produced by the lighting assembly 100 illuminates and reflects off a back wall 104, and a ceiling 106. The lighting assembly 100 is positioned at a wall board 108. To complete an installation process, the lighting assembly 100 can be completely embedded in the wall 102 by covering it with drywall mud and painting it to blend in with the wallboard 108. By way of example, the lighting assembly 100 and the wallboard 108 can be covered by a second wallboard 109 shown here as only partially covering the wallboard 108 and the lighting assembly 100. As shown in FIG. 1, the lighting assembly 100 provides soft, indirect lighting that appears to “float” above the wall 102. By way of example, but not limitation, the lighting assembly can be used to create a cove lighting effect on a ceiling without building an actual cove, to outline an architectural element like a door or window with a grazing light to create a floating effect, or create a “reverse baseboard” at a bottom of a wall.

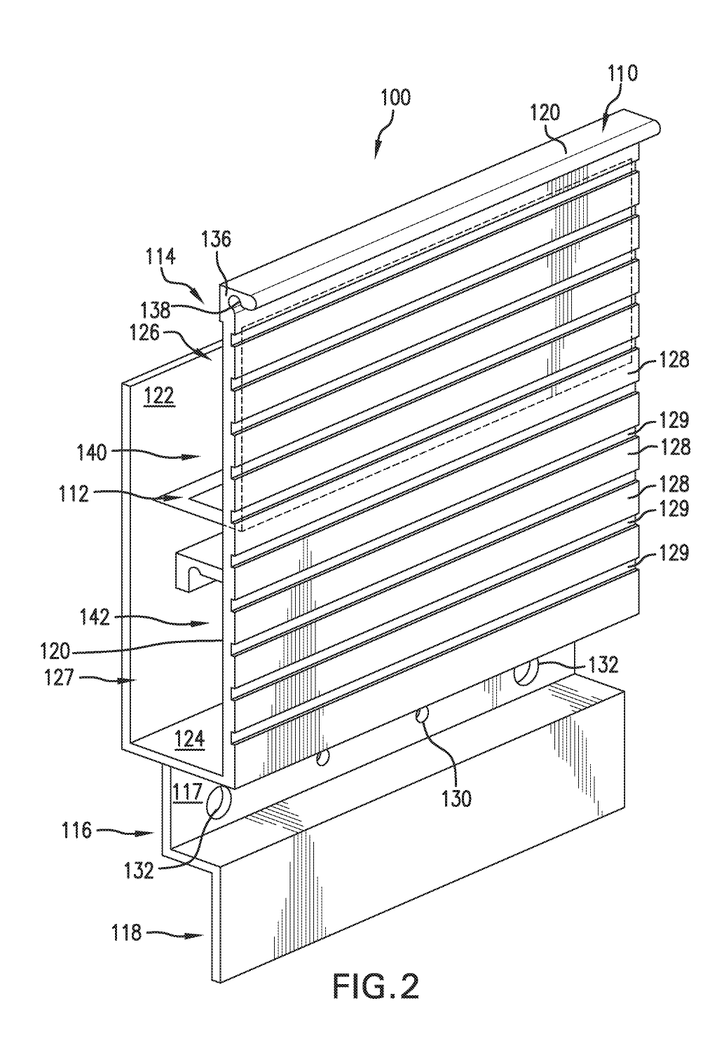

FIG. 2 depicts an example embodiment of the lighting assembly 100. The lighting assembly 100 can comprise a housing 110, and a light apparatus 112 coupled to the housing 110 and supported and secured therein. The housing 110 can include a channel 114 for accommodating the light apparatus 112, a trough 116 configured for mounting the housing 110 and for coupling multiple housings 110 to one another, and a flange 118. The channel 114 can be bounded by a front plate 120 a back plate 122 and a base 124. In a non-limiting example embodiment, the base 124 is perpendicular to both the front plate 120 and the back plate 122 and provides a longitudinal dimension for the housing 110. A side aperture 127 can be defined by front and back plates 120 and 122. By way of example, the front plate 120, back plate 122, base 124 and flange 118 can comprise material sufficiently rigid for providing adequate support for the light apparatus 112 contained therein, and for withstanding embedment within the wall 102.

The channel 114 comprises an aperture 126 through which the light apparatus 112 can be inserted, releasably coupled to the housing 110, decoupled from the housing 110, and removed therefrom. It is noted that the housing 110 can be variously oriented, depending on the desired application. For example, while shown in FIG. 1 as having the flange 118 “below” the trough 116, with the channel 114 aperture 126 oriented towards the ceiling 104, it is contemplated that the housing 110 can be rotated as desired so that the aperture 126 is directed towards a floor, a wall, a window, or other structure (not shown). As can be discerned from FIGS. 1 and 2, the front plate 120 can be of greater dimension than the back plate 122. Consequently, as shown in FIG. 1, when the lighting assembly 100 is mounted, the front plate 120 is visible, but the back plate 122 is entirely blocked by the front plate 120, and, as a result, is not visible to an observer. Therefore, the only surfaces of the housing 110 that an installer need cover with drywall mud and spackling are the front plate 120, the flange 118, and possibly a portion of the trough 116. In an example embodiment, the front plate 120, the flange 118 and the trough 116 may be configured with corrugated surfaces having a pattern of alternating ridges 128 and grooves 129 that facilitates the application and adhesion of drywall mud. The back plate 122 need not be corrugated since it need not be concealed or embedded. Prior art devices typically required both a front plate and a back plate be aligned, installed separately, muddied and spackled, making the installation more challenging, more expensive, and more time-consuming than an apparatus of the present invention, particularly when the front and back plates were affixed to two different walls or architectural surfaces. In an example embodiment, the thickness or depth of a lighting assembly can be about the same thickness of a sheet of gypsum or wallboard, such as taught by U.S. Pat. No. 8,109,659 to Doubek, which is incorporated herein in its entirety by reference.

As will be discussed more thoroughly herein, the presence of the trough 116 provides several advantages over prior art lighting devices. The trough 116 can be separated from and recessed with respect to the back plate 122. Consequently, mounting screws can be inserted through the trough 116 without contacting or affecting the back plate 122. Similarly, the trough 116 can be separated from the front plate 120, eliminating the risk of rippling or raised edges in the front plate 120 during the mounting process that can complicate integration into a wall, ceiling or other structure. Raised edges can be hard to mud over without the drywall mud compound subsequently cracking as it dries. In addition, raised edges can require an operator to extensively feather the compound to mask height differences between the raised edges and a mounting surface. In an example embodiment, one or more mounting holes 130 configured to receive mounting screws can be drilled at desired locations in a rear wall 117 at the trough 116, either at the factory during the manufacture process, or in the field during installation. Referring to FIG. 1, mounting screws can inserted through mounting holes 130 and screwed into a surface behind the lighting assembly 100, such as the back wall 104 or other structure (not shown) behind the wallboard 108. Providing mounting screws to the trough 116 essentially mounts the front plate 120 and the back plate 122 simultaneously, an advantage over prior art fixtures that required front and back plates to be installed separately. Due to its recessed relationship with the front plate 120, any raised edges in the trough 116 that may result from the mounting screws should not pose a problem when embedding the housing 110. Prior art cove light apparatus typically required an operator to insert one or more screws through a back plate and/or a front plate that could cause rippling that can complicate achieving a smooth and level surface when the plates are spackled.

In an example embodiment, the trough 116 can also be configured for coupling adjacent housings 110. While some prior art devices can include a tab that can be used by an installer to align adjacent housings, they typically do not provide a means by which adjacent housings can be physically coupled. When housings are aligned, but not actually connected to one another, their positions relative to each other can shift during the installation process. This shifting can cause result in housings that end up misaligned by the time the installation process is finished. The present invention avoids such problems by providing assemblies that can be positively connected to one another.

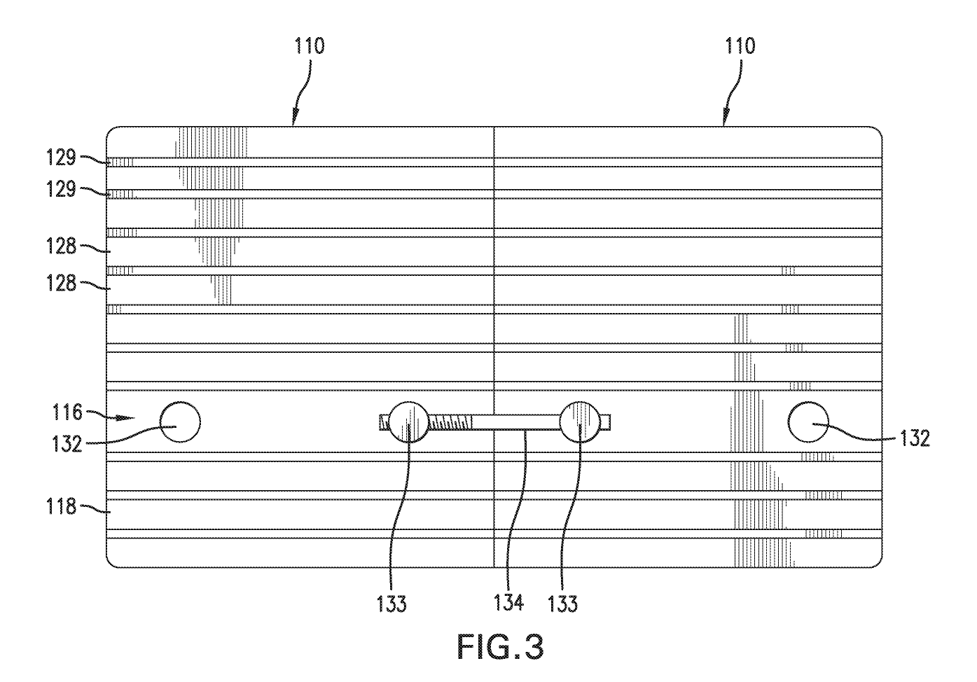

By way of example, as shown in FIGS. 2 and 3, the trough 116 can comprise one or more coupling apertures 132, preferably near its ends. Preferably, the coupling apertures can be drilled at a manufacturing facility. Barrel nuts 133 can be inserted at the coupling apertures 132. A coupling bolt 134 can be received at the barrel nut 133 of a first housing 110, and be received at a second barrel nut 133 of a second housing 110, adjacent to the first housing 110 (FIG. 3). The barrel nuts 133 can then be tightened to provide a rigid and straight connection between the adjacent housings 110. Coupling adjacent housings 110 using a hex head wrench or similar tool to tighten the coupling bolt through the trough 116 enables adjacent housings 110 to be bolted together without contacting the front plate 120 or back plate 122 of either the first or second housing 110.

In an exemplary embodiment, the housing 110 can include one or more additional features that can facilitate the coupling of adjacent units in a manner that is not only simple to perform, but also results in accurately aligned housings 110. For example, the front plate 120 can comprise a front lip 136 comprising an alignment receptor 138 that can be configured to receive an alignment means (not shown). An alignment means can be embodied in various forms. For example, an alignment means can be in the form of a pin, stand-alone or integrated at the housing 110, having a first end that can be received at a first alignment receptor 138 at a first housing 110, and a second opposing end that can be received at a second alignment receptor 138 at a second housing 110. In an example embodiment, the housing 110 can be configured with an alignment tab (not shown), and an alignment receptor 138 configured to receive an alignment tab. An alignment tab of a first housing can be inserted at an appropriately configured alignment receptor of a second adjacent housing. Other alignment means will occur to those skilled in the art.

The channel 114 can comprise an apparatus portion 140 for receiving and accommodating the light apparatus 112, and a wireway l42 for receiving and accommodating supply wiring (not shown) for the light apparatus 116. Accommodation of supply wiring within the housing 114 is a significant advantage of the present invention over the prior art. Prior art light fixtures typically connect external supply wiring to a series of interconnected LED arrays at a feed end of a light fixture. Unfortunately, the initial supply voltage decreases as it travels from array to array along the length of the fixture. As a result, arrays positioned near the end of the run can have a noticeable decrease in lumen output, causing dim or dark spots to appear. This problem can be of particular concern in regard to apparatus in which multiple housings are coupled together to provide a light fixture that spans the width of one or more walls. The present invention solves that problem by providing space for supply wiring within the channel 114 to permit multiple voltage connections for arrays within an apparatus comprising multiple housings coupled together. Several supply wires can be run down the length of the channel 114 in the wireway l42 so that different supply wires can provide voltage to different arrays so that all lighting elements can receive sufficient voltage to produce a desired lumen output.

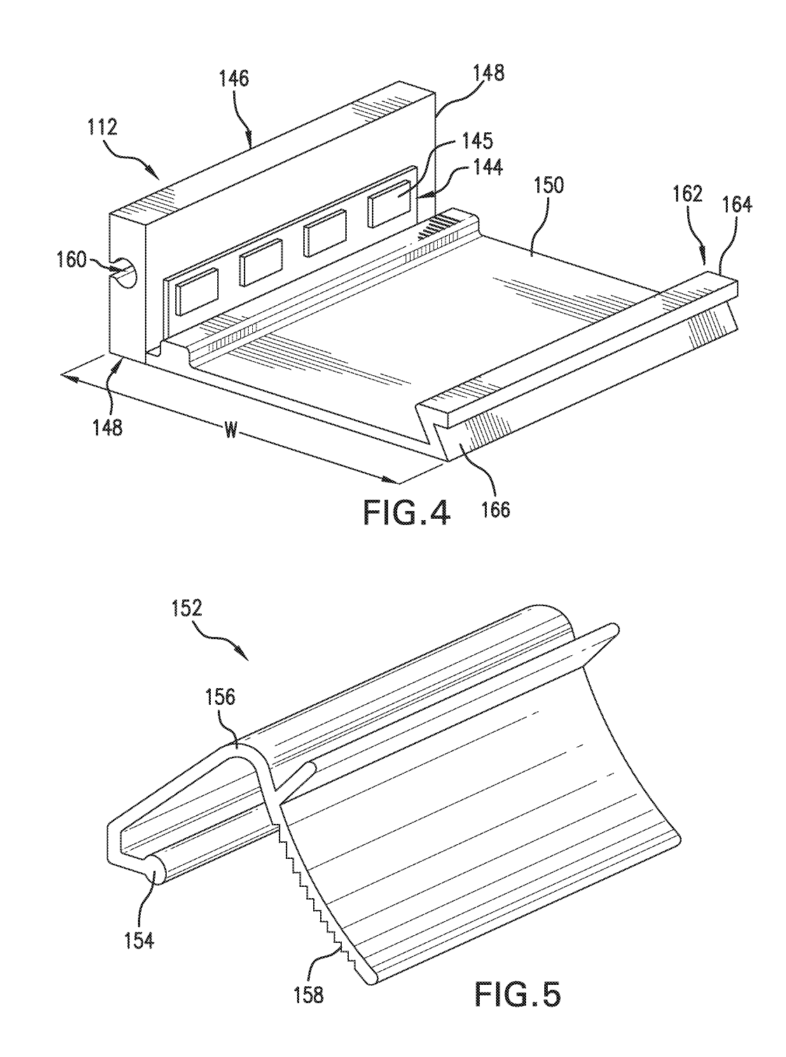

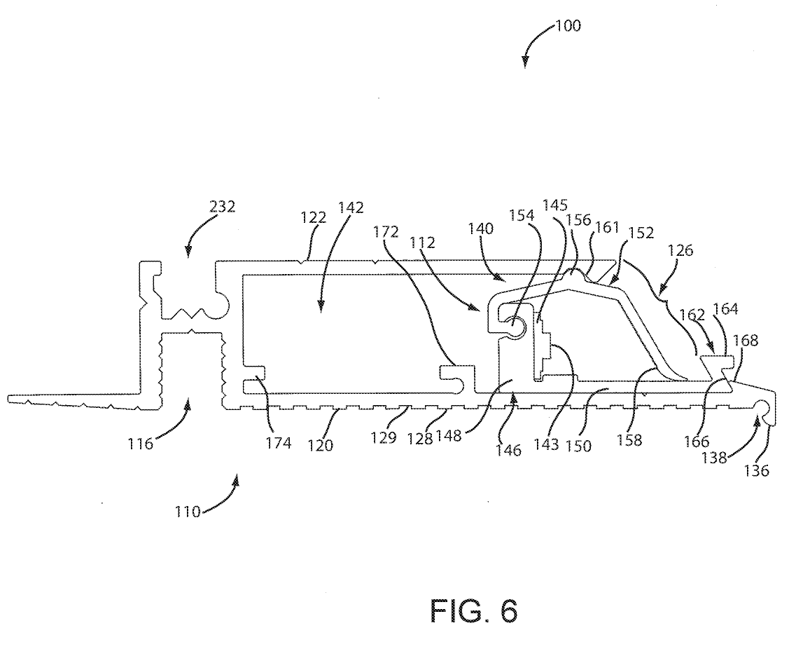

Referring to FIGS. 4 and 5, in an exemplary non-limiting embodiment, the light apparatus 112 comprises a light source coupled to a heat sink 146. As discussed herein, a light source is an element or elements configured to produce light or electromagnetic radiation such as, but not limited to, light-emitting diode (LED) sources, incandescent sources, phosphorescent sources, fluorescent sources, electroluminescent and other luminescent sources, high-intensity discharge sources, etc. of various tones, colors and intensities. For illustrative purposes, the present disclosure will describe an embodiment in which a light source is in the form of an LED, which can include variably packaged LEDs configured to emit various spectra of radiation. For purposes of discussion herein, “LED” can refer to a single LED or to one or more LEDs arranged in an array. By way of non-limiting example, a light source can comprise an LED strip 144 comprising one or more LEDs 145 disposed on a flexible tape or backing that can be cut in a predetermined length. In an example embodiment, the LED strip 144 can have a rear backing configured to adhere to the heat sink 146; however, alternative ways to couple a light source to the heat sink 146 are also contemplated. For example, a heat conductive adhesive can be applied to the heat sink 146, and an LED strip 144 can be applied thereto. It is contemplated that a light source is configured with a means for connection with an external source of power.

In general, light elements, particularly LEDs, are prone to fail when they overheat. The example lighting assembly 100 addresses this concern by providing an assembly in which light-producing elements are arranged within the housing 110 in a manner that quickly and efficiently conducts heat away from them. By way of example, the heat sink 146 can comprise a support portion 148 configured for coupling and supporting a light source, such as the LED strip 144, and a contact portion 150 configured for contact with the housing 114. The support portion 148 can be of sufficient size and substance to adhere, accommodate, and support a light source. As shown in the example lighting assembly 100, the support portion 148 can be oriented at an angle with respect to the contact portion 150. While illustrated in a perpendicular relationship, it is contemplated that the angle between the support portion 148 and the contact portion 150 can be greater or smaller than 90°, depending on a desired lighting effect and application. In an example embodiment, the LED strip 144 is in contact with the support portion 148 throughout its entire rear surface; providing ample surface area for the conduction of heat to the heat sink 146. The angled relationship between the support portion 148 and the contact portion 150 allows a light source to be oriented at a desired angle with respect to the housing 110, while still enabling the heat sink 146 to quickly transfer heat away from a light source to the housing 110. In an example embodiment the heat sink 146 comprises a heat conductive material such as aluminum.

Because the heat sink contact portion 150 is, throughout its width W, configured for contact with the housing front plate 120, heat can be quickly transferred from the heat sink 146 to the housing 110. Preferably, the front plate 120 comprises a thermally conductive material, such as, but not limited to aluminum, enabling it to further dissipate heat away from the housing 110 to the wall 102, which is typically composed of gypsum or crushed stone and can also function as a heat sink. While an example embodiment of a light apparatus of the invention is discussed herein for illustrative purposes as comprising a light source coupled to a heat sink, it is contemplated that a lighting assembly of the invention can employ a light apparatus without a heat sink.

In general, depending on the size and configuration of a light fixture, lighting elements may not be disposed uniformly along its longitudinal dimension. As a result, some portions of the fixture may not produce as bright a light as other portions, causing dim areas to occur in the light pattern produced. To avoid this phenomenon, in an example embodiment, the light apparatus 112 can further comprise a lens. FIG. 5 depicts an example lens 152 releasably coupled to the heat sink 146 and configured to diffuse emitted light. The lens 152 can diffuse light to avoid dim spots in the light pattern produced by the lighting assembly 100. The lens 152 can comprise a transparent material such as, but not limited to, glass, plastic, acrylic or other material that is of sufficient rigidity to couple the heat sink 146, while remaining sufficiently flexible to permit depression and/or manipulation by an operator when the lens is coupled to the heat sink 146, and the light apparatus 112 is inserted into the channel 114. Shown here for illustrative purposes as the example embodiment 152, it is understood that a lens of the present invention can be variably embodied with alternative shapes and faces, and configured to provide various light distribution patterns as desired.

The heat sink 146 and the lens 152 can be configured to releasably engage one another. Referring to FIG. 5, in an example embodiment, the lens 152 can comprise a rounded protrusion 154, a curved bulge 156 and a spring arm 158. The heat sink support portion 148 can comprise a concave groove 160 configured to receive and snap fit the rounded protrusion 154 disposed at the lens 152. When the heat sink 146 and the lens 152 are engaged, they can be moved as a unit together into, out of, and within the housing channel 114.

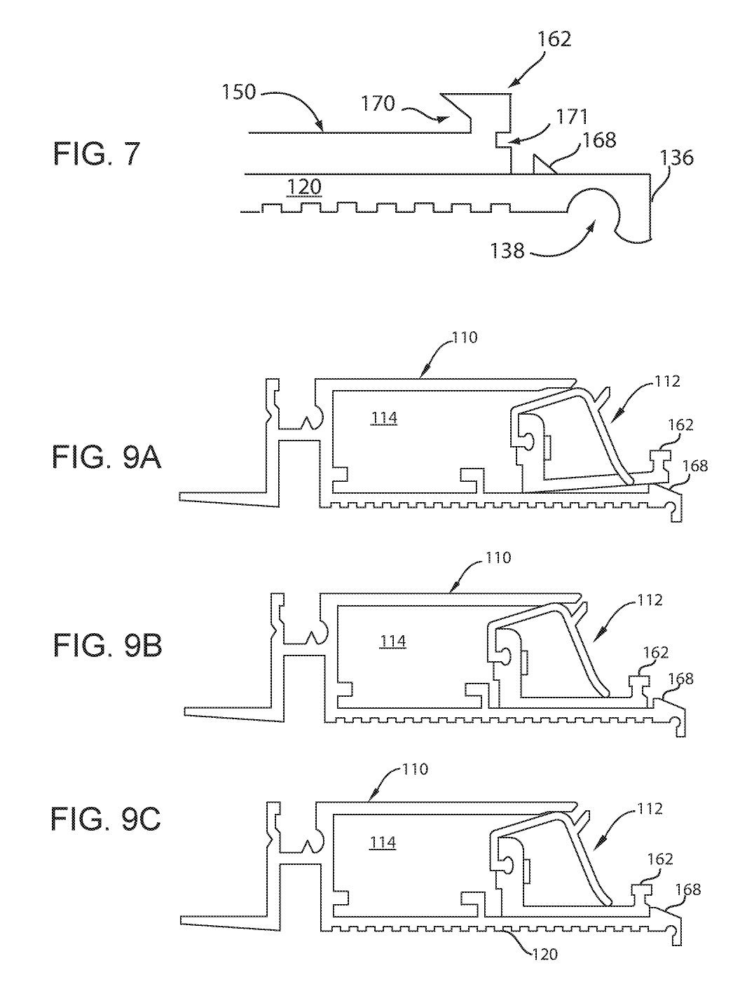

As shown in FIG. 6, in an example embodiment, the housing 110 and the lens 152 can be configured to releasably engage one another. For example, housing 110 can be configured with a rounded divot 161 at the channel back plate 122, configured to receive and snap fit the curved bulge 156. Engagement of the lens 152 at the channel 114 can also secure the heat sink 146 with the housing 110. The lens spring arm 158 can impose a force that can maintain engagement of the lens 152 with the back plate 122 at the divot 161, and can maintain engagement of the heat sink 146 with the front plate 120 of the housing 110 as described below. It is noted that the examples discussed above are not limiting, and that a lens can be variably configured to releasably engage a housing and/or a light apparatus.

By way of example, the light apparatus 112 can comprise an apparatus coupler component 162 at the heat sink 146 configured to releasably engage a housing coupler component 168. For example, FIGS. 5 and 6 show the contact portion 150 of the heat sink 146 terminating with an apparatus coupler component 162 in the form of a “z-foot” having an upper portion 164, and an angled portion 166 oriented at an angle with respect to the upper portion 164. The housing 110 can be configured with a housing coupler component 168, depicted in FIGS. 5 and 6 in the form of an angled receptor that can be configured to receive and friction fit the angled portion 166 of the apparatus coupler component 162 in the form of a z-foot.

When the lens 152 is coupled to the heat sink 146 through its engagement with the heat sink support portion 148, it can exert a force that can press and maintain the apparatus coupler component 162 against the housing coupler component 168 in a friction fit, locking the light apparatus 112 in an engaged position. As can be seen from FIG. 6, the heat sink support portion 148 need not rest against a support within the channel since its engagement with the housing 110 is sufficient to maintain it in position. The angled portion 166 of the coupler component 162 can be of sufficient length to permit insertion of a tool, such as the flat blade of a screwdriver, at the intersection of the upper and angled portions 164 and 166 to press against the coupler component 162 (shown here in the form of a z-foot) to disengage it from the angled receptor 168. The curved bulge 156 of the lens 152 is configured to rest in the divot 161. As the heat sink contact portion 150 is pushed back, the spring action of the lens spring arm 158 presses the curved bulge 156 up into the divot 161 which pushes the heat sink 146 forward towards the aperture 126. As the coupler component 162 (shown as a z-foot) is lifted over the housing coupler component 168 (embodied here as an angled receptor), the heat sink 146 and the coupled lens 152 are easily removed.

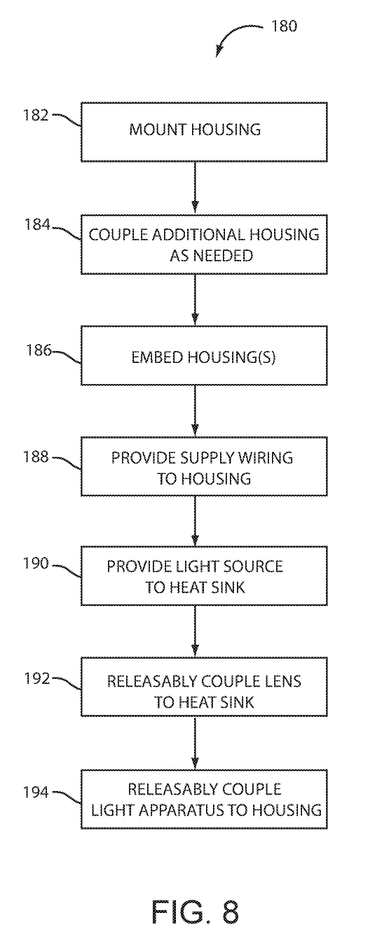

It is contemplated that other forms and types of couplers at a housing and at a light apparatus can be used to achieve the same purpose of releasable engagement of a light apparatus at a housing. For example, as shown in FIG. 7, the heat sink contact portion 150 can terminate in a coupler component 162 having a dovetail 170 on a lens side and a pry-out divot 171 on an opposing side. To release the light apparatus 112 from the housing 110, an operator can use a hook to grasp the dovetail 170 and pull the light apparatus 112 upward and outward.

The light apparatus 112 can be configured to releasably couple the back plate 122 with or without a lens. For applications in which there is a desire for lighting that is brighter than that which can be achieved with the use of a lens, it is contemplated that the invention can be practiced without the lens 152. In an example embodiment, the housing 110 can be configured to receive, engage or otherwise cooperate with a spring component (not shown) at the heat sink 146 or elsewhere, configured to push the light apparatus 112 into a friction fit with the housing 110. For example, the heat sink support portion 146 can comprise a spring component, such as but not limited to, a spring arm (not shown), configured to force and maintain the coupler component 162 in contact with a housing coupler component 168. It is contemplated that a light apparatus with or without a heat sink can be configured to releasably engage a housing with or without employment of a spring component.

The width of the channel 114 is defined by the distance between the front plate 120 and the back plate 122 and can vary depending on the type of light apparatus to be accommodated at the housing 110. In a non-limiting example embodiment, when a light source is embodied as an LED array, and a lens is employed, the housing 110 can have a longitudinal dimension of around 625 inches, with the front plate 120 having a width around 2.6 inches, and the back plate having a smaller width around 1.8 inches. The distance between the front plate 120 and the back plate 122 can be around 0.625 inches, or the thickness of a typical gypsum board. By way of example, but not limitation, the front plate 120 can extend a minimum length past the edge of the back plate 122, equal to the distance between the front plate 120 and the back plate 122 to create a minimum cut off angle of 45 degrees to prevent the back lip and the lens 152 from being viewed from most viewing angles. In an example embodiment, the trough 116 can be recessed from the front plate 120 by around 0.36 inches.

Referring back to FIG. 6, the housing 110 can be configured with one or more guides 172 within the channel 114. The guide 172 can separate the apparatus portion 140 of the channel 114 and the wireway 142, and can serve various purposes. For example, the guide 172 can function as a backstop for the light apparatus 112, preventing it from being pushed too far down in the channel 114. It can also guide or secure any wiring stowed in the wireway 142. In an example embodiment, the housing 110 can include the guide 172 as well as a lower guide 174 which can be used to secure wiring stowed within the channel 114.

The flange 118 can extend “below” the trough 116. The housing 110 can be arranged so that the flange 118 abuts a wall or other architectural surface behind it that can provide additional support to the housing 110. However, the additional support is not necessary, and the housing 110 can be mounted without any structure or surface behind/under the flange 118. The flange 118 can be configured with the same grooves 129 and ridges 128 of the front plate 120 so that it can be muddied and sanded to appear as part of a wall or other architectural feature.

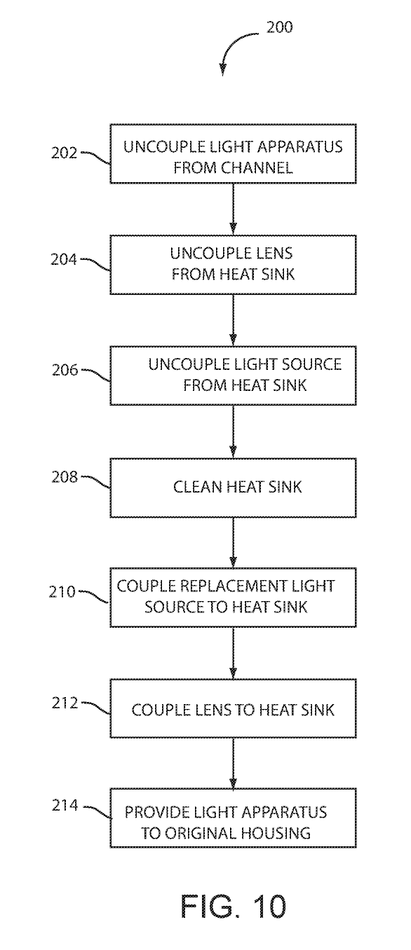

FIG. 8 shows a flow diagram of a method 180 of practicing the invention. At block 182, housing for a lighting assembly can be mounted. For example, an operator can position the housing 110 at a desired position at the wall 102; for instance the housing 110 can be positioned so that the trough 116 sits on the wallboard 108 and the flange 116 abuts and extends over a front surface the wallboard 108. The operator can insert one or more mounting screws through pre-drilled holes in the trough 116 to mount the housing 110 at the back wall 104.

At block 184 any additional housings that are necessary to provide a lighting assembly of a desired length can be coupled and mounted through the trough 116. For example, for an application in which two adjacent housings 110 are required, an operator can insert an alignment pin at the alignment receptor 138 at the front plate 120 of the first housing 110 that was mounted at block 182, then position a second housing 110 adjacent the first mounted housing 110 so that an alignment pin (or alternatively an alignment tab) is received at its alignment receptor 138. Providing an alignment pin to both the first and second housings 110 assures that the respective front lips 136 are even. Having aligned the two adjacent housings 110, an operator can couple them together, for example by bolting the two together at the trough 116. For example, an operator can insert a bolt 134 to barrel nuts 133 at apertures 132 of the adjacent housings 110. Additional housings 110 can be coupled as necessary by repeating the above process.

At block 186, the housing 110 can be embedded at an architectural structure. For example, the housing 110 can be embedded at the wallboard 108 by applying drywall mud compound to the front plate 120, the trough 116 and the flange 116. As discussed earlier herein, the back plate 122 need not be mudded since it is concealed by the front plate 120. The corrugated pattern of grooves and ridges at the front plate 120 facilitates adhesion of the drywall mud, spackling, etc. After the mud has dried, the operator can sand the mud and blend the areas at which the housing 110 abuts the wall board 108. The operator can paint the sanded surface and, if necessary, the wallboard 108. The housing 110 then becomes a permanent part of a wall formed by the wallboard 108. The operator can clean out any dust or debris that may have fallen into the channel 114 during the embedding process.

At block 188, supply wiring can be provided to the embedded housing(s). In an example embodiment, supply wiring of sufficient length and number to fully power all light sources contained within the coupled housings 110 can be pulled from a junction box, power supply, or other power source (not shown). By way of example, two supply wires can be pulled, a first supply wire for providing a voltage to a first light source at the first housing 110, and a second supply wire for providing a voltage to a second light source at the second housing 110. The second supply wire can be pulled over and/or through the channel 114 of the first housing 110 to the channel 114 of the second housing 110. An operator can provide supply wiring to the housings 110 through the side apertures 127 and/or the apertures 126.

At block 190, a light source can be provided to a heat sink. In an example embodiment, a light apparatus can be assembled by an operator in the field. By way of example, an operator can inspect the heat sink support portion 148 to verify that it is clean, wiping and cleaning it with alcohol to remove any oils or dust that would prevent an adhesive from properly adhering and that would allow air bubbles to form between a light source and the heat sink support portion 148. Air bubbles can prevent heat generated by the LEDs 145 from being wicked away by the heat sink 146, posing a risk that the LEDs 145 will overheat and prematurely fail. The operator can cut an LED tape into the appropriately sized LED strip 144 for the heat sink 146. In general, an LED tape is cut at the end of a diode array, which typically comprises four to six diodes.

If the LED strip 144 comprises an adhesive backing, the operator can then apply the adhesive surface to the heat sink support portion 148, pressing it firmly into place. By way of example, the operator can position the LED strip 144 so that its center is at the center of the heat sink support portion 148. In an example embodiment, the heat sink 146 is configured so that centering the LED strip 144 at the heat sink support portion 148 centers a light source at the housing 110. Additional light sources can be coupled to additional heat sinks as required for a lighting assembly of a particular size and application. Alternatively, it is contemplated that a light source can be coupled to a heat sink at a manufacturing facility or retail center to reduce installation time in the field.

At block 192 a lens can be releasably coupled to a heat sink of a light apparatus. For example, the rounded protrusion 154 of the lens 152 can be provided to the concave groove 160 of the heat sink support portion 148 so that the lens 152 and the heat sink 146 are releasably engaged. Additional lens 152 can be coupled to additional heat sinks 146 as required.

At block 194, a light apparatus can be releasably coupled to an embedded housing. For example, the light apparatus 112 can be coupled to the housing 110 embedded at the wallboard 108. The first supply wire can be pulled out of the channel 114 and coupled to a first light apparatus 112. The first supply wire can then be returned to the channel 114 and pushed below the guide 172 into the wireway 142. The wired light apparatus 112 can then be provided to the channel first portion 140 through the channel aperture 126.

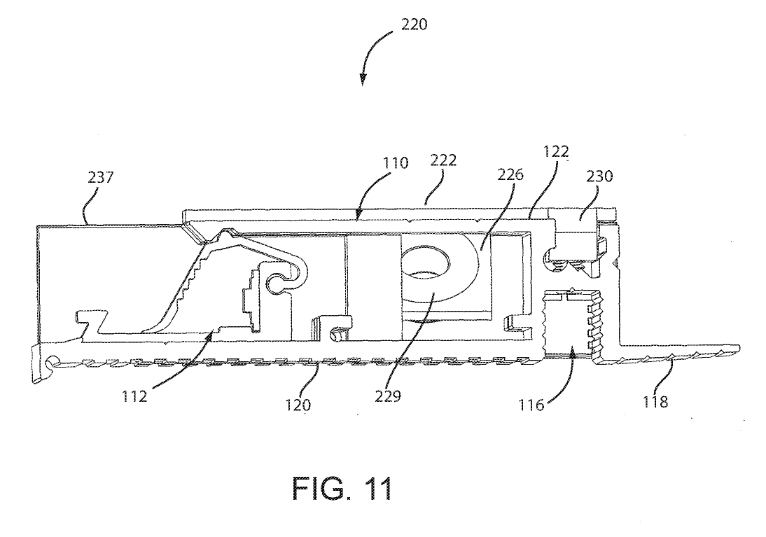

A lighting assembly of the invention can be configured so that a light apparatus is releasably captured or engaged within a housing between front and back plates. By way of example, FIGS. 9A-9C show three possible positions of the light apparatus 112 with respect to the housing 110 during its insertion into the channel 114 and its removal therefrom. Position 1, shown in FIG. 9A, referred to as an outer unengaged position, wherein the light apparatus 112 is within the channel 114, but is not as deep in the channel 114 as is required to engage the channel 114. The coupler component 162 is not engaged with the front plate 120, but rather extends outward and beyond the housing coupler component 168, shown in the form of an angled receptor. The operator can move the light apparatus 112 farther into the channel 114 to position 2, shown in FIG. 9B, referred to as an inner unengaged position wherein the light apparatus 112 is deeper into the channel 114, while remaining within the channel apparatus portion 140 and in front of, or above, the guide 172, with the coupler component 162 within the channel 114 but not engaged at the housing 110. Finally, an operator can move the light apparatus 112 to position 3, shown in FIG. 9C, referred to as an engaged position, fitting the rounded protrusion 154 of the lens 152 to the divot 161 at the back plate 122, and engaging the coupler component 162 at the housing coupler component 168 (angled receptor) at the front plate 120 to lock/engage the light apparatus 112 at the housing 110.

While discussed above in the context of the light apparatus 112 comprising the lens 152, it is contemplated that a similar procedure can be used to provide a light apparatus without a lens to a housing of the invention. For example, a light apparatus in which a heat sink comprises a spring component can be moved from position 2 (FIG. 9B) to position 3 (FIG. 9C) to snap fit a spring component at a divot or other feature at the back plate 122 configured to receive a spring component of the heat sink 146.

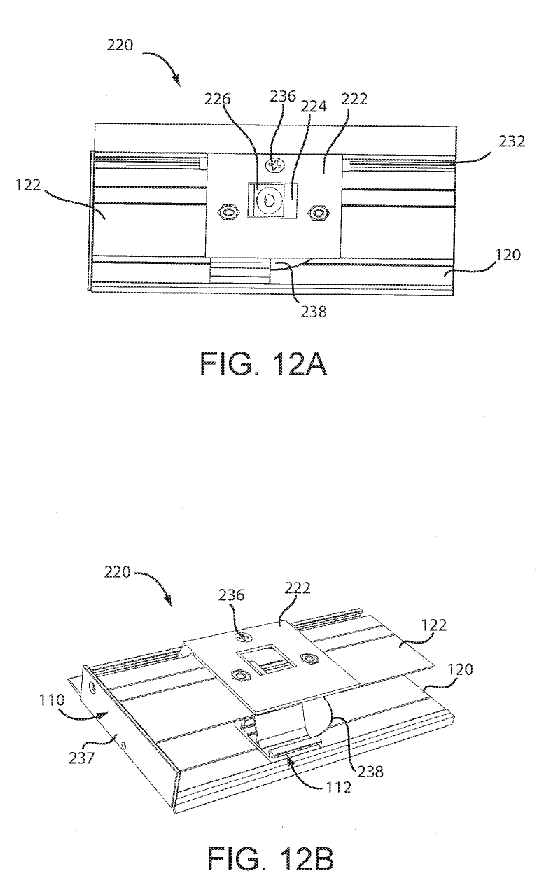

Not only is a lighting assembly of the invention simple to install, it is configured for easy replacement of the light source in the field should maintenance or repair becomes necessary. The embedded housing 110 and the wall 102 can remain undisturbed while a light apparatus is decoupled therefrom. FIG. 10 shows a flow diagram for an example method 200 for replacing a light at a lighting assembly of the invention. At block 202, a light apparatus can be decoupled from a permanently installed housing. For example, the light apparatus 112 can be removed from the housing 110 embedded at the wall 102. By way of example, an operator can insert the flat blade of a screw driver, a putty knife, or the like at the coupler component 162 (e.g. a z-foot) of the heat sink 146 to release it from the housing coupler component 168 (shown herein as an angled receptor) at the front plate 120. In doing so, the operator can release the curved bulge 156 of the lens 152 from the divot 161 at the back plate 122, and move the light apparatus 112 from engaged position 2 to unengaged inner position 3 (see FIG. 9). An operator can then move the light apparatus 112 from unengaged inner position 3 to unengaged outer position 1, pulling the light apparatus 112 toward him, and lifting up the heat sink contact portion 150 from the housing front plate 120. From that position, the operator can then fully remove the light apparatus 112 from the channel 114 and disconnect supply wiring coupled to the LED strip 144.

At block 204, an operator can decouple a lens from a light apparatus. For example, an operator can decouple the lens 152 from the heat sink 146 by releasing the rounded protrusion 154 from the concave groove 160. At block 206 a light source can be uncoupled from a heat sink. For example, the LED strip 144 can be detached from the heat sink support portion 148. At block 208 a heat sink can be cleaned. For example, an operator can wipe heat sink support portion 148 with alcohol to remove any adhesive residue or other dust, dirt, debris, etc. At block 210, replacement light sources can be provided to the lighting assembly. For example, the operator can attach a new LED strip 144 to the heat sink support portion148 as described at block 190 of method 180. At block 212 a lens can be releasably coupled to a heat sink. For example, the lens 152 can be coupled to the heat sink support portion 148 as described at block 192 of the method 180. At block 214 a replacement light apparatus can be provided to the original intact housing. For example a replacement light apparatus 112 resulting from actions taken at blocks 210-212 above can be provided to the embedded original housing 110 from which a previous light apparatus 112 was removed as describe at block 94 of method 180.

A lighting assembly of the present invention can be easily installed during new construction prior to completion of a wall or ceiling, or mounted at an existing structure. For installation while a building is being constructed, the lighting assembly 100 can be installed as drywall is put up for walls or ceilings, or while a floor is being installed for floor applications. As shown in FIG. 1, drywall can be cut to accommodate the lighting assembly 100 thereon, then additional drywall can be mounted and drywall mud can be applied so as to integrate the lighting assembly 100 into the wall (or ceiling, etc.) into the structure being built.

As will be explained in further detail below, the invention's accommodation of feed wiring within its housing also facilitates its later installation at a pre-existing wall, ceiling, or other architectural structure. In prior art devices, feed wiring that provides electricity to a light fixture is typically connected to light fixture wiring at a junction box behind a wall, ceiling or floor of a building. Problems can arise when there is no room for a junction box at a desired installation location, or when the light fixture, once mounted, prevents future service access to the junction box. By accommodating feed wiring within itself, a lighting assembly of the present invention obviates the need to consider accommodation of a junction box at a desired location, and allows easy access to the electrical connections between feed wiring and apparatus wiring should future servicing be required.

However, accommodating feed wiring within the channel 114 can require that certain aspects of an installation process be considered. For example, feed wiring of sufficient length for splicing with apparatus wiring should be pulled into the housing 110, and may need to be pulled through a plurality of coupled housings 110. The width of the channel 114 may require that a feed cable be bent sharply upon its entry into the housing 110. The feed cable should be protected from sharp edges that can damage the cable or cause a short circuit. Once inside the housing 110, the feed wiring may need to be trimmed by an installer. In addition, it is preferable that some form of strain relief be provided to secure the wiring so that the spliced connections are not compromised by an installer tugging or pushing on the feed wiring or apparatus wiring. An embodiment of the invention can be configured to address any or all of these considerations.

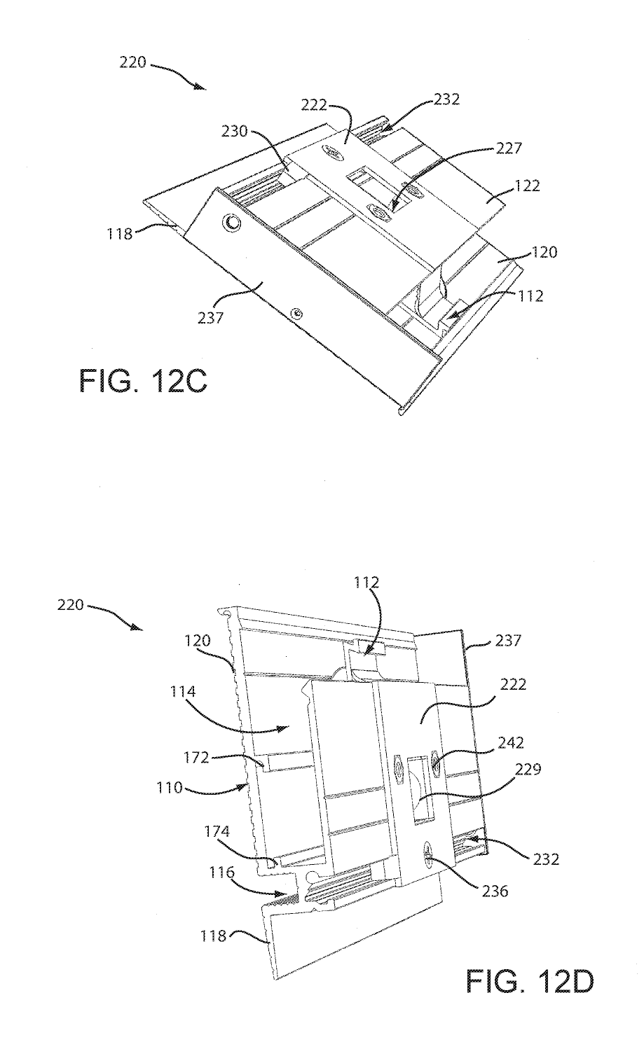

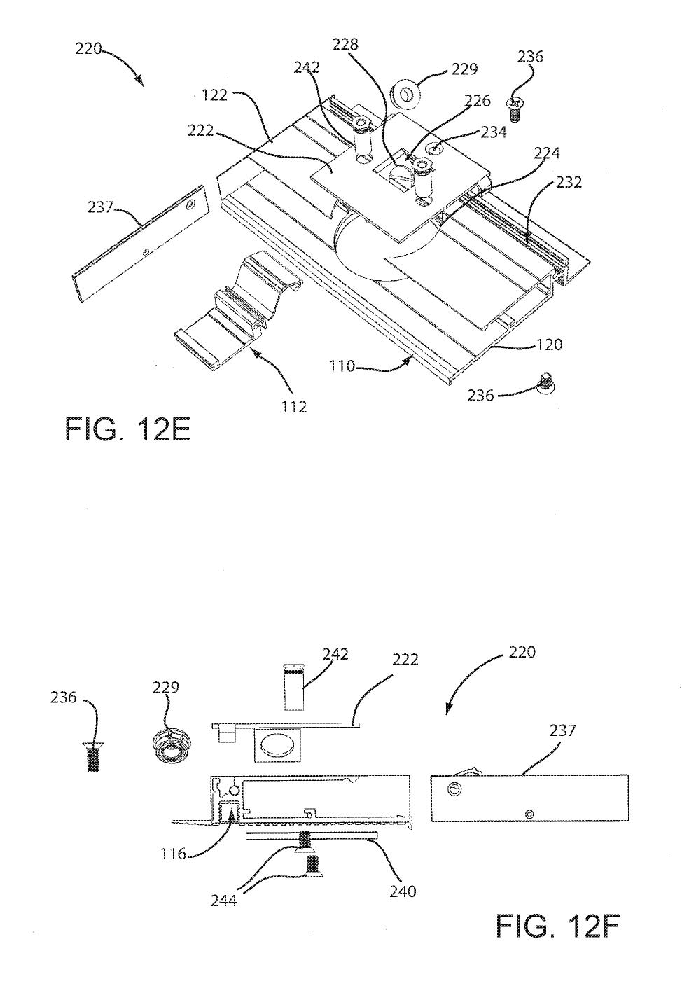

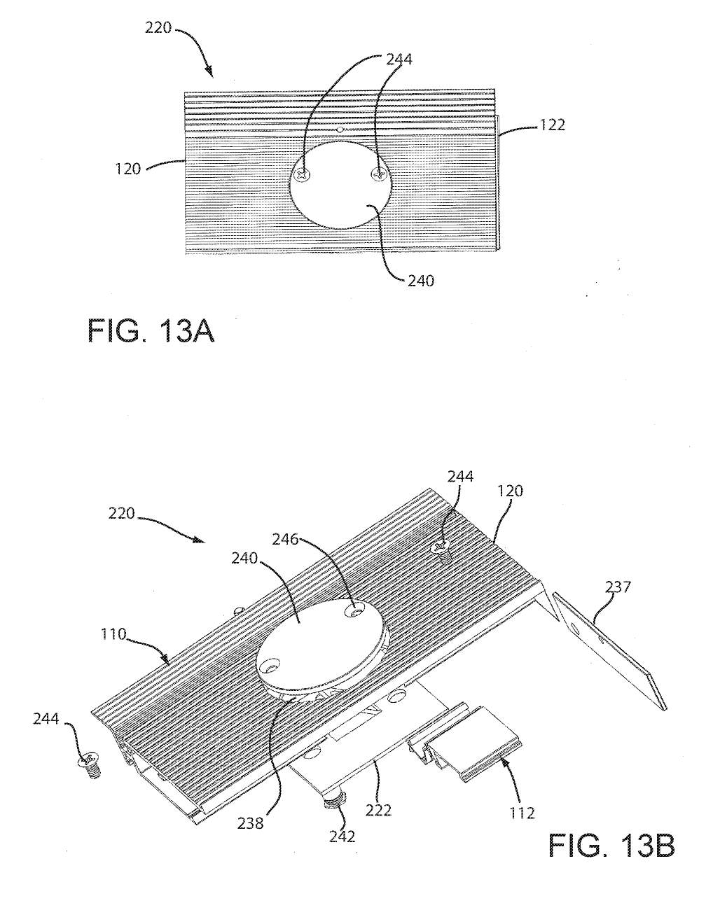

FIG. 11 shows an example embodiment 220 of a lighting assembly, with FIGS. 12A-12F, and 13A-13B showing various additional views. Referring to FIG. 11 and FIGS. 12A-12F, by way of example, the housing 110 can include a rear access panel 222 configured to cover a rear gap or aperture 224 at the back plate 122 through which feed wiring can enter the housing 110. The rear access panel can include a tab 226 configured to angle into the housing 110 through a panel opening 227. The tab 226 can be configured with a tab aperture 228, configured for passage of the feed wiring into the channel 114. By way of example, the tab aperture 228 can be fitted with a smooth-surfaced grommet 229. The smooth curved surface of the grommet 229 allows the feed cable to be pulled through the rear panel 222 and turned at a sharp angle into the housing 110, while protected from nicks and cuts. The grommet 229 can also provide strain relief for the feed cable after it has been pulled inside, and after it has been spliced with apparatus wiring.

In an example embodiment, the rear access panel 222 can be removably coupled to the housing 110 and can include one or more arms 230 configured to be received and friction fitted at a rear gutter 232 of the housing 110. In addition, the rear access panel 222 can include one or more holes 234 configured to receive a screw 236 or other coupling means configured to couple the rear access panel 222 to the housing 110. As shown in FIGS. 11A, 11D, the screw 236 can be received at the hole 234 and the rear gutter 232. In an example embodiment, the housing 110 can include a sidewall 237 at one or both ends, extending between the front plate 120 and the back plate 122.

Referring to FIGS. 13A-13B, the example embodiment 220 further includes a front aperture 238 at the front plate 120 that is covered by a removable access panel 240. In an exemplary embodiment, the front access panel 240 and the front aperture 238 can have a round shape as shown in the drawings. Various means can be employed to secure the front access panel 240 at the housing 110. In the example embodiment 220, the rear access panel 222 can be fitted with one or more Pem studs 242 that can be configured to receive screws 244 provided to the front access panel 240 through holes 246. The employment of the Pem studs 242 provides the additional advantage of preventing the front access panel 240 from falling into the channel 114. The front access panel 240 can be completely removed to allow an installer to reach into the channel 114 through the front aperture 238 and pull feed wiring through the grommet 229 while lifting and/or supporting the housing 110 at a wall or ceiling. It is preferable that the front aperture 238 be disposed in an arrangement with respect to the rear aperture 224 that facilitates an installer reaching through the front aperture 238 and pulling feed wiring into the channel 114 through the rear aperture 224 and the grommet 228. In an example embodiment, the front access panel 240 and/or the rear access panel 222 can comprise a ferrous material such as steel that can be detected by a magnet. This allows an operator tasked to service an embedded assembly to find the location of spliced wiring in a wall, ceiling or other structure simply by running a magnet over the area at which the apparatus is embedded.

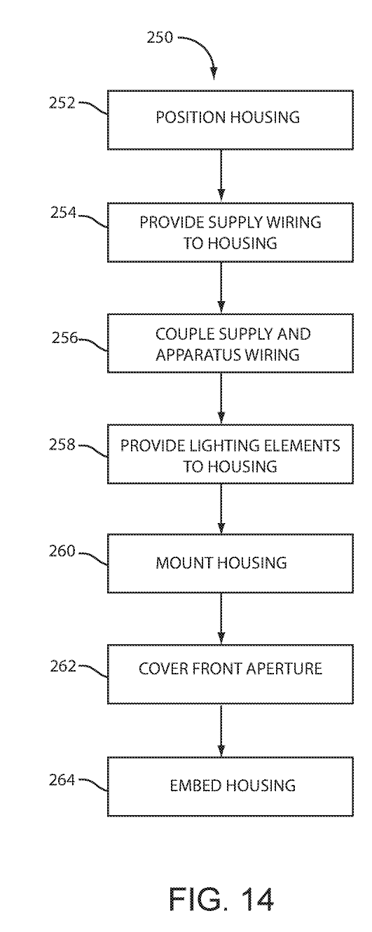

FIG. 14 depicts a flow diagram of an example method 250 for installing a lighting assembly of the present invention at an existing architectural structure such as an existing wall or ceiling in a building. At block 252, a housing can be positioned at a desired location. For example, the housing 110 can be held up at a desired location at a wall, with the front access panel 240 removed. At block 254, supply wiring can be provided to the housing 110. For example, an installer can reach through the front aperture 238, and through the channel 114 to grab supply wiring and pull it through the rear access panel opening 227 and the grommet 229, angling down the tab 226. At block 256 supply wiring can be coupled to light apparatus wiring. For example, the feed wiring can be pulled up through the channel aperture 126 and connected to wiring for the LED strip 144. The spliced wiring can then be pushed back through the channel aperture 126 into the wireway 142. At block 258, lighting elements can be provided to the housing. For example, an operator can provide the light apparatus 112 to the apparatus portion 140 and move the light apparatus 112 to position 3, an engaged position, fitting the rounded protrusion 154 of the lens 152 to the divot 161 at the back plate 122, and engaging the coupler component 162 (e.g. a z-foot) at the housing coupler component 168 (e.g. angled receptor) at the front plate 120 to lock/engage the light apparatus 112 at the housing 110.

At block 260 the housing can be mounted. For example, an operator can insert screws into holes 130 in the trough 116. At block 262 the front aperture 238 can be covered. For example, an operator can provide the front access panel 240 to the housing 110, and insert screws 244 into Pem studs 242. At block 264 the mounted housing can be embedded. For example, an operator can cover the front plate 120 with drywall mud which can later be sanded and painted.

Thus the invention provides a lighting assembly in which light replacement is simpler and less time consuming than that of prior art lighting devices in which light elements are adhered to an embedded housing. Prior art devices require an operator to detach LEDs from the housing, which often resulted in adhesive residue remaining in the housing. When, as typically is the case, lights are regressed within a housing, the residue can be difficult to remove as an operator must reach into a channel to clean and wipe all of its sides. After cleaning the channel, it can be difficult for an operator to visually inspect it to confirm that all residue has been removed. Remaining residue can impede adherence of newly installed LEDs in the housing. The present invention can avoid these difficulties by providing an apparatus in which LEDs are attached to the heat sink 146 that can be decoupled from an installed housing 110.

A lighting assembly of the invention provides a housing that can be permanently embedded at a wall or other mounting surface, and a light apparatus configured to releasably engage the housing to facilitate removal therefrom. The housing has a channel comprising a front plate and a back plate; wherein, because the front plate conceals the back plate, only the front plate needs to be mudded and spackled to embed the housing at a wall. The channel provides an apparatus portion for supporting and securing the light apparatus, and a wireway portion for accommodating supply wiring for the light apparatus. A wireway allows multiple supply wires to be run for assemblies in which multiple housings accommodate multiple light sources, thereby providing sufficient voltage for each array and avoiding dark spots in a lighting pattern. Mounting the housing and coupling multiple housings together can be performed through a trough in the housing, thereby protecting the front and back plates from forces applied by screws such as “oil canning” and raised edges and corners.

A light apparatus can comprise a light source, such as one or more LEDs, coupled to a heat sink. The heat sink can be configured to releasably engage the housing, preferably at the front plate and the back plate, securing and suspending the light apparatus at the channel. A spring component at the heat sink can be fit against the back plate, and a z-foot at the heat sink can be fit against an angled receptor at the front plate. Alternatively, a lens releasably coupled to the heat sink can be fitted against the back plate can have a spring component that can force the z-foot against the angled receptor to secure the light assembly within the housing.

A lighting assembly can be configured with a housing having removable rear and front access panels that cover rear and front apertures at the back and front plates respectively. The rear access panel can be configured with a tab having a grommet through which feed wiring can be pulled into the channel and bent without risk of being cut or nicked. The front access panel can be removed while a lighting assembly is being installed to allow an operator to reach into the channel and pull feed wiring through the grommet. The front access panel can subsequently be coupled to the housing prior to covering the housing with drywall mud, paint, etc.

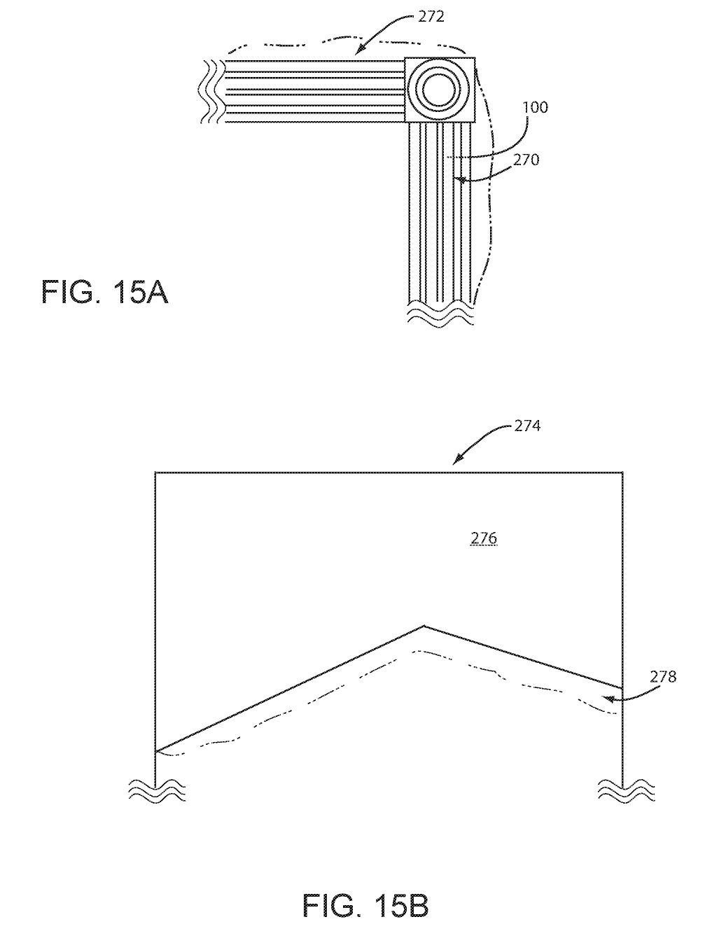

As required, illustrative embodiments have been disclosed herein, however the invention is not limited to the described embodiments. For example, while discussed herein in the context of mounting at a wall or ceiling, it is contemplated that a lighting assembly of the invention can be used for a variety of applications, and that a variety of means and materials can be used to conceal a lighting assembly of the invention. For example, as an alternative to embedding and concealing an assembly at a wall or ceiling by drywall, it is contemplated that an assembly can be disposed at a door and concealed by door trim, or at a chair rail and concealed by chair rail molding, etc. Accordingly, a variety of materials, such as, but not limited to wood, stone, tile can be used, as shown in FIG. 15A in which wood trim 270 conceals the lighting assembly 100, which provides an illumination pattern 272.

A lighting assembly can be used in conjunction with a variety of materials to create wall art, and can be disposed at a change of plane of any type of material such as the stone, tile, wood trim, etc. mentioned above, as well as drywall. FIG. 15B shows an example of “wall art” 274 created by a lighting assembly 100 (not shown) concealed at drywall 276, which provides an illumination pattern 278.

Thus, as will be appreciated by those skilled in the art, aspects of the invention can be variously embodied and configured. Methods are not limited to the particular sequence described herein and may add, delete or combine various steps or operations. The invention encompasses all systems, apparatus and methods within the scope of the appended claims.

We claim:

1. A lighting assembly, comprising:
a light apparatus comprising a light source;
a housing configured to receive said light apparatus; and
wherein said housing further comprises a trough for receiving a mounting means configured to mount said housing to a mounting surface without contact with said channel.

2. The lighting assembly of claim 1, wherein said trough is configured for coupling a first said housing to a second said housing.

3. The lighting assembly of claim 1, wherein said light apparatus further comprises a heat sink.

4. A lighting assembly, comprising:
a housing; and
a light apparatus releasably secured at said housing.

5. The lighting assembly of claim 4, wherein said light apparatus comprises a light source coupled to a heat sink.

6. The lighting assembly of claim 4, wherein said light apparatus comprises a lens.

7. The lighting assembly of claim 4, wherein said light apparatus comprises a coupling component configured to engage said housing.

8. The lighting assembly of claim 4, wherein said housing comprises a cavity configured to receive and accommodate supply wiring.

9. The lighting assembly of claim 4, wherein said light apparatus is maintained in a friction fit with said housing.

10. A housing, comprising:
a longitudinal channel having a longitudinal aperture;
a longitudinal trough having an opening oriented perpendicular with respect to said longitudinal aperture; and
wherein said channel is bounded by a front plate, and a back plate separated from said front plate by a channel base, said front plate having dimensions configured to conceal said back plate when said housing is mounted to a surface.

11. The housing of claim 10, wherein said trough is configured to receive a means for mounting said housing to said surface.

12. The housing of claim 10, wherein said channel is configured to receive a light source.

13. The housing of claim 10, wherein said channel is configured to receive supply wiring for said light source.

14. The housing of claim 10, wherein said trough is free from contact with said back plate.

15. The housing of claim 10, wherein said housing is configured to releasably engage a light apparatus.

16. The housing of claim 10, wherein said housing is configured to receive an alignment means configured to align said housing with a second said housing.

17. The housing of claim 10, wherein said trough comprises a first sidewall comprising a portion of said channel base, a second sidewall perpendicular to said first sidewall, and a third sidewall perpendicular to said second sidewall and parallel with said first sidewall.

18. The housing of claim 10, further comprising a rear access panel at said back plate configured to provide access to said channel.

19. The housing of claim 10, further comprising a front access panel at aid front plate removable to provide access to said channel.

20. A lens comprising:
a rod portion configured to engage a groove at a heat sink configured to couple a light source; and
a curved apex portion configured to engage a divot at a back plate of a channel configured to house said heat sink.
